(19) United States
(12) Patent Application Publication
(10) Pub. No.: US 2026/0349110 A1
(43) Pub. Date: Nov. 5, 2026

(54) RADIO WAVE SENSOR

(71) Applicant: SUMITOMO ELECTRIC INDUSTRIES, LTD., Osaka-shi, Osaka (JP)

(72) Inventors: Yusuke YAHATA, Osaka-shi (JP); Nobuo HIGASHIDA, Osaka-shi (JP); Masaki KISHI, Osaka-shi (JP); Suguru YAMAGISHI, Osaka-shi (JP); Ichiro KUWAYAMA, Osaka-shi (JP); Yutaro MIKI, Osaka-shi (JP)

(73) Assignee: SUMITOMO ELECTRIC INDUSTRIES, LTD., Osaka-shi, Osaka (JP)

(21) Appl. No.: 19/471,620

(22) PCT Filed: Feb. 8, 2024
(86) PCT No.: PCT/JP2024/004228

§ 371 Date: Oct. 1, 2025

(30) Foreign Application Priority Data
Apr. 5, 2023 (JP) 2023-061237

(51) Int. Cl. G01S 13/91; G01S 7/02; G01S 13/42; G01S 13/58

(52) U.S. Cl. CPC G01S 13/91; G01S 7/027; G01S 13/42; G01S 13/58

(57) ABSTRACT

This radio wave sensor comprises: an antenna unit that includes a plurality of antenna elements for transmitting and receiving radio waves; a housing that accommodates the antenna unit; and a reflection plate that has a reflection surface which reflects a portion of the radio waves transmitted or received by the antenna unit. The antenna unit has an antenna region which is a region in which the plurality of antenna elements are arranged and which is for transmitting and receiving the radio waves. The reflection plate is arranged so that the reflection surface faces downward, and when the antenna region is viewed from the front, the front end of the reflection surface is positioned above the center of the antenna region.

### TECHNICAL FIELD

The present disclosure relates to a radio wave sensor. This application claims priority based on Japanese Patent Application No. 2023-061237 filed on Apr. 5, 2023, the entire contents of which are incorporated herein by reference.

### BACKGROUND ART

A radio wave sensor for traffic monitoring detects an object (a vehicle, a pedestrian, or the like) in a detection area set on a road. The radio wave sensor is installed at a high place such as near an upper end of a support column with a radio wave radiation surface facing obliquely downward so as to radiate a radio wave to the detection area in front, but the position near directly below the radio wave sensor is likely to be a blind spot. Due to the restriction of an installation position of the radio wave sensor, it may be required to include the position near directly below the radio wave sensor in the detection area.

Patent literature 1 discloses a radio wave sensor including a transmission unit capable of transmitting a radio wave from a first antenna by restricting a radiation range to a first area that is an area of a start portion of pedestrian crossing and does not include all of the pedestrian crossing, a reception unit configured to receive the radio wave from the first area, and a detection unit configured to detect a target object in the first area based on the radio wave received by the reception unit. The transmission unit of the radio wave sensor disclosed in Patent literature 1 is further capable of transmitting a radio wave from a second antenna by restricting a radiation range to a second area including a portion of the pedestrian crossing farther from the radio wave sensor than the first area, the reception unit is configured to further receive a radio wave from the second area, and the detection unit is configured to further detect a target object in the second area based on the radio wave from the second area received by the reception unit.

### CITATION LIST

### Patent Literature

Patent literature 1: Japanese Unexamined Patent Application Publication No. 2015-148578

### SUMMARY OF INVENTION

A radio wave sensor according to an aspect of the present disclosure includes an antenna portion including a plurality of antenna elements configured to transmit and receive a radio wave, a housing configured to house the antenna portion, and a reflective plate having a reflective surface configured to reflect a portion of the radio wave transmitted or received by the antenna portion. The antenna portion has an antenna region that is a region in which the plurality of antenna elements are arranged and in which the radio wave is transmitted and received. The reflective plate is arranged such that the reflective surface faces downward. In a front view of the antenna region, a front end of the reflective surface is located above a center of the antenna region.

The present disclosure includes a reflective plate for an antenna having a configuration included in a radio wave sensor, in addition to the radio wave sensor having the above-described configuration.

### BRIEF DESCRIPTION OF THE DRAWINGS

FIG. 1 is a diagram showing an example of use of a radio wave sensor according to an embodiment.

FIG. 2 is a perspective view showing an example of the configuration of the radio wave sensor according to the embodiment.

FIG. 3 is a perspective view showing an example of an internal configuration of the radio wave sensor according to the embodiment.

FIG. 4A is a diagram for explaining an example of a radio wave radiation range by a radio wave sensor in which a reflective plate is not provided.

FIG. 4B is a diagram for explaining an example of a radio wave radiation range by the radio wave sensor according to the embodiment.

FIG. 5A is a side view of a circuit board and a reflective plate showing an example of a positional relationship between an antenna region and a reflective surface.

FIG. 5B is a side view of a circuit board and a reflective plate showing another example of a positional relationship between an antenna region and a reflective surface.

FIG. 5C is a side view of a circuit board and a reflective plate showing still another example of the positional relationship between an antenna region and a reflective surface.

FIG. 6 is a perspective view of a circuit board and a reflective plate showing an example of a position relationship between an antenna region and a reflective surface in a first direction X.

FIG. 7A is a perspective view showing a configuration of an antenna with a reflective plate used for a simulation.

FIG. 7B is a front view showing a configuration of an antenna with a reflective plate used for the simulation.

FIG. 7C is a side view showing a configuration of an antenna with a reflective plate used for the simulation.

FIG. 8A is a graph showing a simulation result of horizontal directivity of an antenna without a reflective plate.

FIG. 8B is a graph showing a simulation result of vertical directivity of an antenna without a reflective plate.

FIG. 9A is a graph showing a simulation result of horizontal directivity of an antenna with a reflective plate.

FIG. 9B is a graph showing a simulation result of vertical directivity of an antenna with a reflective plate.

FIG. 10 is a diagram showing a walking pattern of a subject in a performance evaluation experiment.

FIG. 11A is a graph showing results of a performance evaluation experiment of an antenna without a reflective plate.

FIG. 11B is a graph showing results of a performance evaluation experiment of an antenna with a reflective plate experimentally manufactured so as to have antenna directivity shown in FIGS. 9A and 9B.

FIG. 12 is a side view of a circuit board and a reflective plate for explaining a setting of positions of a front end and a base end of a reflective surface.

FIG. 13A is a graph showing simulation results of horizontal directivity when θ1=80° and θ2=25°.

FIG. 13B is a graph showing simulation results of vertical directivity in a case of θ1=80° and θ2=25°.

FIG. 14A is a graph showing simulation results of horizontal directivity in a case of θ1=75° and θ2=25°.

FIG. 14B is a graph showing simulation results of vertical directivity in a case of θ1=75° and θ2=25°.

FIG. 15A is a graph showing simulation results of horizontal directivity in a case of θ1=70° and θ2=25°.

FIG. 15B is a graph showing simulation results of vertical directivity in a case of θ1=70° and θ2=25°.

FIG. 16A is a graph showing simulation results of horizontal directivity in a case of θ1=80° and θ2=30°.

FIG. 16B is a graph showing simulation results of vertical directivity in a case of θ1=80° and θ2=30°.

FIG. 17A is a graph showing simulation results of horizontal directivity in a case of θ1=80° and θ2=35°.

FIG. 17B is a graph showing simulation results of vertical directivity in a case of θ1=80° and θ2=35°.

FIG. 18 is a diagram for explaining a reflection region in a reflective surface.

FIG. 19 is a front view showing a configuration of one antenna element.

FIG. 20 is a diagram showing an example of a setting of a length of a reflective surface in a first direction.

FIG. 21A is a graph showing a simulation result of horizontal directivity in a case of a=10.

FIG. 21B is a graph showing a simulation result of vertical directivity in a case of a=10.

FIG. 22A is a graph showing a simulation result of horizontal directivity in a case of a=4.

FIG. 22B is a graph showing a simulation result of vertical directivity in a case of a=4.

FIG. 23A is a graph showing a simulation result of horizontal directivity in a case of a=1.

FIG. 23B is a graph showing a simulation result of vertical directivity in a case of a=1.

FIG. 24A is a graph showing simulation results of horizontal directivity when X3 is changed at an interval of 1 mm in a range from 1 to 20 mm.

FIG. 24B is a graph showing simulation results of vertical directivity when X3 is changed at an interval of 1 mm in a range from 1 to 20 mm.

FIG. 25 is a perspective view showing a first modification of a radio wave sensor according to the embodiment.

FIG. 26 is a perspective view showing a second modification of the radio wave sensor according to the embodiment.

FIG. 27 is a perspective view showing a third modification of the radio wave sensor according to the embodiment.

FIG. 28 is a perspective view showing a fourth modification of the radio wave sensor according to the embodiment.

### DETAILED DESCRIPTION

### Problems to be Solved by Present Disclosure

In the apparatus disclosed in Patent literature 1, it is necessary to provide the second antenna in addition to the first antenna in order to expand a detection area.

### Advantageous Effects of Present Disclosure

According to the present disclosure, a detection area of a radio wave sensor can be expanded without increasing the number of antennas.

### Overview of Embodiments of the Present Disclosure

The following is a summary of embodiments of the present disclosure.
(1) A radio wave sensor according to an embodiment of the present disclosure includes an antenna portion including a plurality of antenna elements configured to transmit and receive a radio wave, a housing configured to house the antenna portion, and a reflective plate having a reflective surface configured to reflect a portion of the radio wave transmitted or received by the antenna portion. The antenna portion has an antenna region that is a region in which the plurality of antenna elements are arranged and in which the radio wave is transmitted and received. The reflective plate is arranged such that the reflective surface faces downward. In a front view of the antenna region, a front end of the reflective surface is located above a center of the antenna region. Thus, the radio wave directed upward can be reflected downward while the radio wave radiated from the antenna portion in a front direction is prevented from being blocked. Thus, the detection area of the radio wave sensor can be expanded without increasing the number of antennas.
(2) In the above (1), a front end of the reflective plate may be located above an upper end of the antenna region. Thus, it is possible to further prevent a main lobe radiated from the antenna portion from being blocked.
(3) In the above (1) or (2), the antenna portion may further have an antenna surface that is a flat surface on which the plurality of antenna elements are arranged in a first direction that is a horizontal direction, and, in a plane perpendicular to the first direction, an angle formed by the antenna surface and a first straight line connecting a front end of the reflective surface and a center of the antenna region to each other may be 75° or more. Thus, the front end of the reflective plate is located in a range where strength of the radio wave is high, and a gain in the lower part of the antenna portion may be improved.
(4) In the above (3), in a plane perpendicular to the first direction, an angle formed by the antenna surface and a second straight line connecting a base end of the reflective plate and a center of the antenna region to each other may be 30° or less. Thus, the base end portion of the reflective plate is located in a range where the strength of the radio wave is high, and the gain in the lower part of the antenna portion may be improved. Here, the “base end” is an end opposite to the front end. Specifically, the “base end” is an end at which the reflective plate is attached to a member (for example, a housing) serving as a base on which the reflective plate is supported.
(5) In any one of the above (1) to (4), an angle formed by the reflective surface and the antenna surface may be within a range of 60° to 90°. Thus, the radio wave can be reflected on a position close to the radio wave sensor, and the detection area can be expanded.
(6) In any one of the above (1) to (5), a length of the reflective surface in the first direction may be larger than or equal to a length of the antenna region in the first direction. Thus, a large portion of side lobes which is directed upwards can be reflected.
(7) In the above (6), a length of the reflective surface in the first direction may be a length including a plurality of reflection regions each determined for a respective one of the plurality of antenna elements. Thus, the radio wave radiated from each antenna element may be reflected from the reflective plate, and the gain of the antenna may be improved.
(8) In the above (7), a length of the reflection region in the first direction may be larger than or equal to four times a length of each of the antenna elements in the first direction. Thus, the reflective plate is located in a range in which the strength of the radio wave is high in the first direction, and it is possible to improve the gain in the lower part of the antenna portion.
(9) In the above (7) or (8), the reflection region may include a region in which strength of a radio wave radiated from the antenna elements is not less than −3 dB relative to radio wave strength of a peak of a main lobe. Thus, it is possible to reflect radio waves having sufficient strength (not less than −3 dB) without exception, and to improve the gain in the lower part of the antenna portion.
(10) In any one of the above (1) to (9), the radio wave sensor may further include a holding portion configured to hold the antenna portion. The reflective plate may be attached to the holding portion. Thus, the reflective plate can be arranged near the antenna portion, and an error in the attachment position of the reflective plate with respect to the antenna portion can be suppressed.
(11) In any one of the above (1) to (10), the housing may be configured to house the reflective plate. Thus, it is possible to protect the reflective plate from wind and rain, and to suppress the positional deviation of the reflective plate.
(12) In any one of the above (1) to (11), the reflective plate may be a flat plate having a rectangular shape. Thus, the configuration of the reflective plate can be simplified.
(13) In any one of the above (1) to (11), the reflective plate may have a plate shape having a bent portion in a direction away from the antenna portion, and includes a first portion closer than the bent portion to the antenna portion and a second portion farther than the bent portion from the antenna portion, and an angle formed by the second portion and the antenna surface may be smaller than an angle formed by the first portion and the antenna surface. Thus, the detection area can be expanded to a position close to the radio wave sensor.
(14) In any one of the above (1) to (4) and (6) to (11), the reflective plate may have a plate shape curved such that a front end thereof is lowered. Thus, the detection area can be expanded to a position close to the radio wave sensor.
(15) In any one of the above (1) to (14), a front end of the reflective plate may have a shape based on a strength distribution of a radio wave reflected by the reflective surface. Thus, it is possible to configure a small reflective plate while ensuring high strength of a radio wave.
(16) In any one of the above (1) to (15), the reflective surface may be configured to cause a reflected wave, the reflected wave being the radio wave that is reflected, to be radiated to a second radiation range closer than a first radiation range to the radio wave sensor, the first radiation range being a range in which the radio wave is radiated to a ground from the antenna portion without being reflected by the reflective surface. Thus, the detection area can be expanded to a position close to the radio wave sensor.
(17) A radio wave sensor according to an embodiment includes an antenna portion including a plurality of antenna elements configured to transmit and receive a radio wave, a housing configured to house the antenna portion, and a reflective plate configured to reflect a portion of the radio wave transmitted or received by the antenna portion. The reflective plate is arranged such that a reflective surface thereof faces downward, the reflective surface being configured to reflect the radio wave. A front end of the reflective plate is located above a center axis of a main lobe radiated from the antenna portion. Thus, a side lobe directed upward can be reflected downward while preventing the main lobe radiated from the antenna portion from being blocked. Thus, the detection area of the radio wave sensor can be expanded without increasing the number of antennas.

### DETAILS OF EMBODIMENTS OF PRESENT DISCLOSURE

Hereinafter, details of the embodiments of the present disclosure will be described with reference to the drawings. At least some of the embodiments described below may be combined as desired.

### [1. Configuration of Radio Wave Sensor]

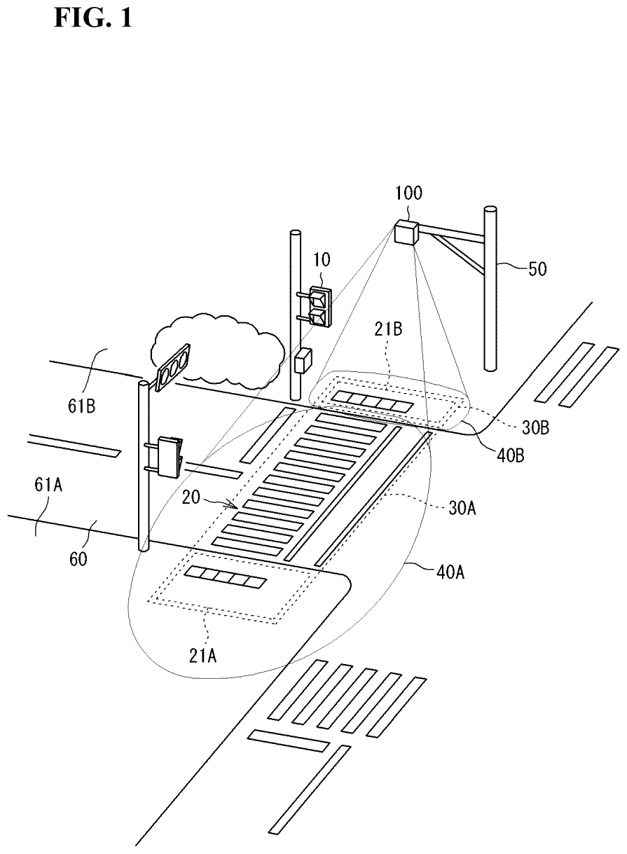

Reference is made to FIG. 1. A radio wave sensor 100 according to an embodiment is a radio wave radar for traffic monitoring, and is configured to detect a pedestrian at a pedestrian crossing 20.

The radio wave sensor 100 is attached to a structure 50 provided on a sidewalk 61B. The structure 50 has a height of several meters, and the radio wave sensor 100 is installed at a height of several meters above the ground.

The radio wave sensor 100 is configured to radiate a radio wave (millimeter wave) onto the pedestrian crossing 20 and receive a reflected wave thereof, thereby detecting an object (for example, a pedestrian, a bicycle, or a vehicle) on the pedestrian crossing 20. More specifically, the radio wave sensor 100 is configured to be capable of detecting a distance from the radio wave sensor 100 to an object on the pedestrian crossing 20, a speed of the object, and a horizontal angle (hereinafter, referred to as an “azimuth angle”) of a position where the object is present with respect to a radio wave radiation axis (a center axis of a main lobe).

The radio wave sensor 100 includes a reflective plate 130 as described later, and is configured to detect an object using a millimeter wave reflected by the reflective plate 130. When the radio wave is reflected from the reflective plate 130, the path length of the radio wave is increased. However, in detecting objects such as pedestrians, bicycles, and vehicles that are sufficiently larger than the wavelengths of millimeter waves (from 1 mm to 10 mm), the increase in the path length of the radio wave by the reflective plate 130 is within the range of errors, and the detection accuracy does not substantially decrease.

A person who passes through the pedestrian crossing 20 and a person who waits for a traffic light are referred to as “passersby”. The passersby include pedestrians and bicycles (specifically, bicycles ridden by passengers). The radio wave sensor 100 is configured to detect a pedestrian and detect a position (distance and azimuth angle) and a speed of the pedestrian.

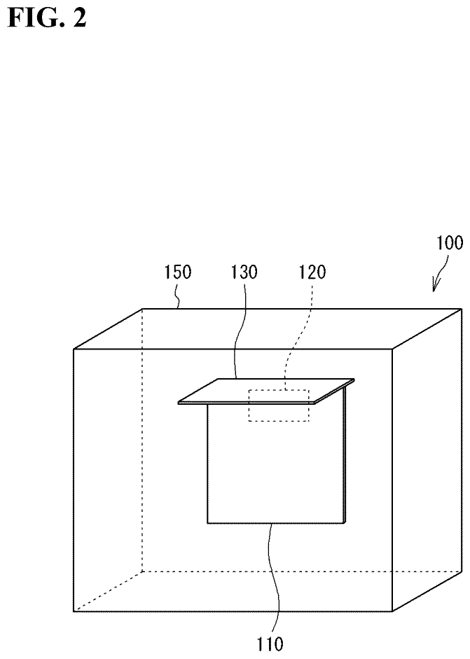

Reference is made to FIG. 2. The radio wave sensor 100 includes a circuit board 110, the reflective plate 130, and a housing 150.

The circuit board 110 and the reflective plate 130 are housed in the housing 150. The housing 150 is an example of a “housing portion”.

The circuit board 110 includes an antenna portion 120. The housing 150 has an outer shape of, for example, a rectangular parallelepiped, and one surface thereof is a transmission-reception surface of a radio wave.

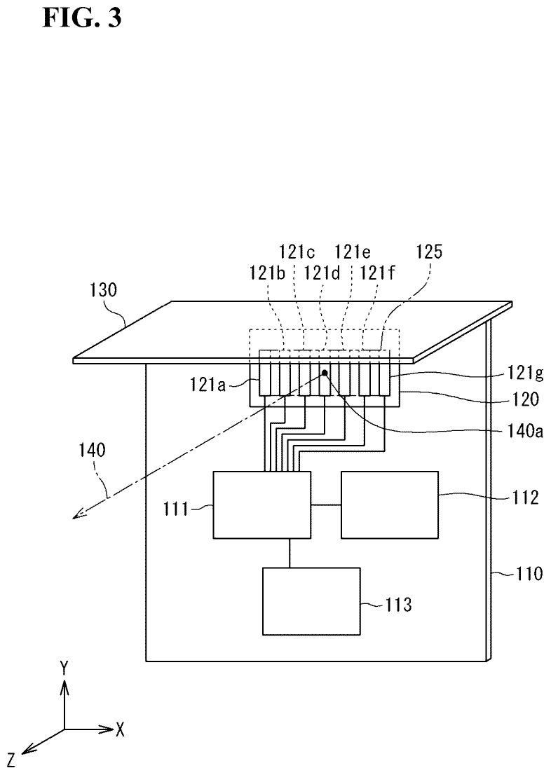

Reference is made to FIG. 3. FIG. 3 shows the circuit board 110 and the reflective plate 130.

The circuit board 110 have a flat plate shape. Hereinafter, one direction along a main surface of the circuit board 110 is referred to as a first direction X. A direction along the main surface of the circuit board 110 and orthogonal to the first direction X is referred to as a second direction Y. A direction orthogonal to the first direction X and the second direction Y is referred to as a third direction Z. The third direction Z is a normal direction of the main surface of the circuit board 110, and is a direction from the main surface of the circuit board 110 toward the radio wave transmission-reception surface of the housing 150.

The radio wave sensor 100 is installed such that the second direction Y is the upward direction. When a first end (the end close to the reflective plate 130 in FIG. 3) of the circuit board 110 in the second direction Y is located on the upper side and a second end (the end far from the reflective plate 130 in FIG. 3) of the circuit board 110 in the second direction Y is positioned on the lower side, a front surface of the housing 150 of the radio wave sensor 100 may be inclined downward. Hereinafter, for the sake of simplicity of description, the second direction Y is also referred to as “upward”, and the opposite of the second direction Y is also referred to as “downward”. The first direction X is also referred to as “leftward”, and the opposite of the first direction X is also referred to as “rightward”. The third direction Z is also referred to as “forward”, and the opposite of the third direction Z is also referred to as “backward”.

The circuit board 110 includes a detection processing circuit 111, a power supply circuit 112, and an interface portion 113 in addition to the antenna portion 120. The circuit board 110 is, for example, a printed circuit board, and each of the antenna portion 120, the detection processing circuit 111, the power supply circuit 112, and the interface portion 113 is configured as a partial circuit of the circuit board 110.

The antenna portion 120 includes reception antenna elements 121a, 121b, 121c, and 121d and transmission antenna elements 121e, 121f, and 121g. The transmission antenna elements 121e, 121f, and 121g are configured to radiate (transmit) radio waves, and the reception antenna elements 121a, 121b, 121c, and 121d are configured to receive the radio waves.

The antenna portion 120 is, for example, an array antenna. Specifically, the reception antenna elements 121a, 121b, 121c, and 121d constitute a reception array antenna, and the transmission antenna elements 121e, 121f, and 121g constitute a transmission array antenna. Hereinafter, the “reception antenna element” and the “transmission antenna element” are also referred to as “antenna elements”.

As shown in FIG. 3, the antenna elements 121a, 121b, 121c, 121d, 121e, 121f, and 121g are arranged in a horizontal row. The reception antenna elements 121a, 121b, 121c, and 121d are arranged in a row to the left and right, and the transmission antenna elements 121e, 121f, and 121g are also arranged in a row to the left and right.

The antenna portion 120 includes an antenna region 125 including the reception antenna elements 121a, 121b, 121c, and 121d and the transmission antenna elements 121e, 121f, and 121g. The antenna region 125 is an area in which the radio wave of the antenna portion 120 is transmitted and received. The reception antenna elements 121a, 121b, 121c, and 121d and the transmission antenna elements 121e, 121f, and 121g are configured on the surface of the circuit board 110. Thus, the antenna region 125 is an area on a XY plane.

A left end of the antenna region 125 coincides with a left end of the antenna element 121a at the leftmost side among the antenna elements 121a, 121b, 121c, 121d, 121e, 121f, and 121g. A right end of the antenna region 125 coincides with a right end of the antenna element 121g at the rightmost side among the antenna elements 121a, 121b, 121c, 121d, 121e, 121f, and 121g. An upper end of the antenna region 125 coincides with an upper end of the antenna element 121f at the uppermost side among the antenna elements 121a, 121b, 121c, 121d, 121e, 121f, and 121g. A lower end of the antenna region 125 coincides with lower ends of the antenna elements 121a, 121b, 121c, 121d, 121e, and 121g. That is, the antenna region 125 is a rectangular area of the minimum area surrounding the antenna elements 121a, 121b, 121c, 121d, 121e, 121f, and 121g.

The detection processing circuit 111 is configured to generate a modulated wave. The generated modulated waves are transmitted from the transmission antenna elements 121e, 121f, and 121g. The transmitted modulated wave is reflected from an object (e.g., a pedestrian, a bicycle, or a vehicle).

In order to detect the azimuth angle of the object, a plurality of (four in the figure) the reception antenna elements 121a, 121b, 121c, and 121d are used. The detection processing circuit 111 is configured to apply a signal process to the received reflected wave. The detection processing circuit 111 is configured to analyze the reflected wave data generated by the signal process, and detect the position (distance and azimuth angle) and the speed of the object.

The interface portion 113 is a circuit for communicating with an external device. The interface portion 113 includes a connector (not shown) and can be connected to an external device via a cable. The interface portion 113 is configured to be capable of transmitting data of the detection result to the connected external device. The interface portion 113 is a wireless communication interface and may be capable of communicating with an external device wirelessly.

The power supply circuit 112 is configured to supply power to the detection processing circuit 111.

The reflective plate 130 is arranged above the circuit board 110. The reflective plate 130 is, for example, a rectangular flat plate. In one specific example, the circuit board 110 and the reflective plate 130 are attached to an inner surface of the housing 150. The inner surface of the housing 150 is a holding portion configured to hold the circuit board 110, and the reflective plate 130 is attached to the holding portion. The attachment structure of the circuit board 110 and the reflective plate 130 is not limited to this. For example, the circuit board 110 and the reflective plate 130 may be attached to a holding member fixed to the inner surface of the housing 150.

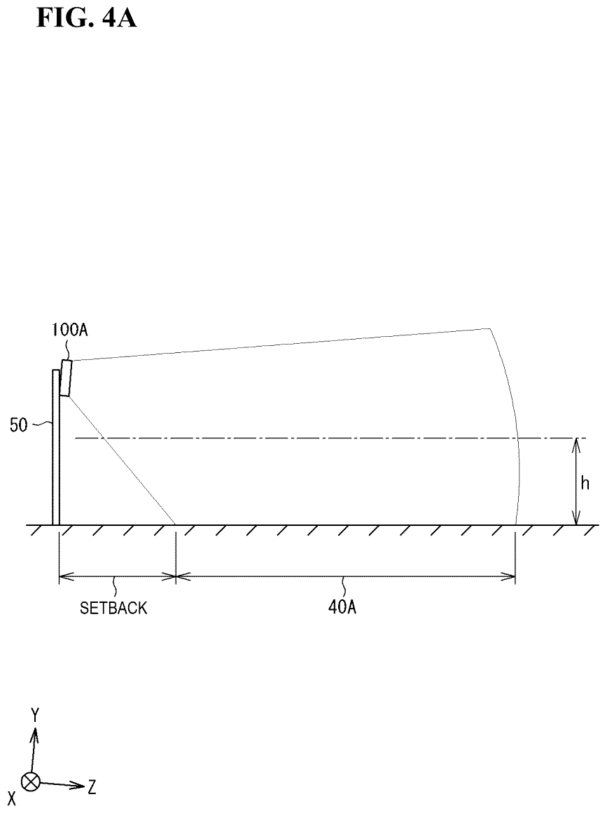

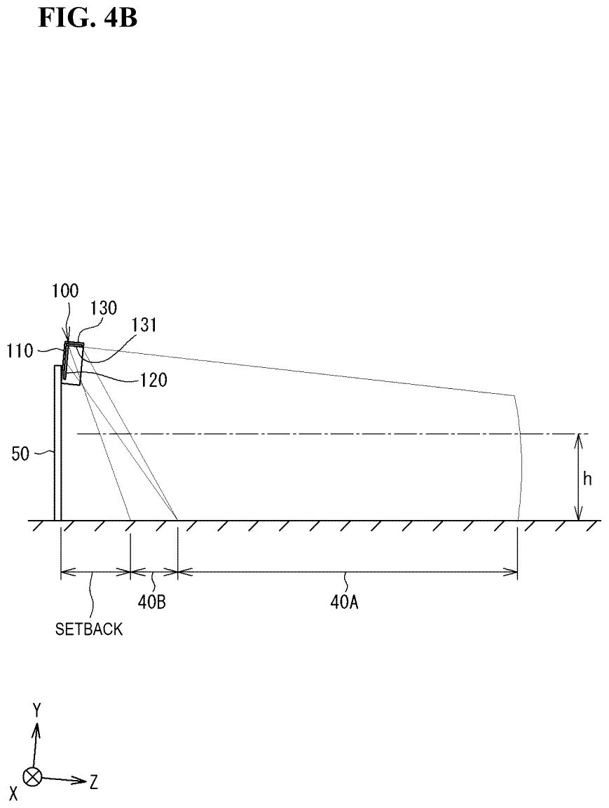

The reflective plate 130 includes a reflective surface 131 (see FIG. 4B) configured to reflect the radio wave. The reflective surface 131 is arranged at a position where a portion of the radio wave transmitted from the antenna portion 120 is reflected. The reflective surface 131 is directed obliquely downward and reflects the radio wave toward the road obliquely downward of the radio wave sensor 100, mainly toward a roadway 60 and a sidewalk 61A in the example of FIG. 1.

The reflective surface 131 is provided on the lower surface of the reflective plate 130. For example, the reflective plate 130 is made of metal. In this case, the lower surface of the reflective plate 130 is the reflective surface 131. In another example, the reflective plate 130 may have a configuration in which a metal plate is attached to the lower surface of a holding plate made of, for example, a synthetic resin. In this case, the lower surface of the metal plate is the reflective surface 131.

### [2. Expansion of Detection Area by Reflective Plate]

Reference is made to FIG. 1. Detection areas 30A and 30B are set that are ranges on a road for detecting an object. The detection areas 30A and 30B are set as a part of radio-wave radiation areas 40A and 40B of the radio wave sensor 100.

The radio-wave radiation area 40A is a range in which a radio wave is directly radiated from the antenna portion 120 of the radio wave sensor 100. The radio-wave radiation area 40B is a range in which a radio wave reflected by the reflective plate 130 among radio waves transmitted from the antenna portion 120 of the radio wave sensor 100 is radiated.

For example, the detection area 30A is set inside the radio-wave radiation area 40A. The detection area 30B is set inside the radio-wave radiation area 40B.

At both ends of the pedestrian crossing 20 connected to the sidewalks 61A and 61B, a pedestrian standby areas 21A and 21B are provided. The standby areas 21A and 21B are set in the sidewalks 61A and 61B provided on both sides of the roadway 60. In the standby areas 21A and 21B, the pedestrian waits for a pedestrian traffic signal 10 to be switched from red lighting (traffic prohibited) to green lighting (traffic permitted).

The structure 50 to which the radio wave sensor 100 is attached is installed on, for example, the sidewalk 61B, which is one of the sidewalks 61A and 61B on both sides of the roadway 60. Hereinafter, the standby area 21A provided in the sidewalk 61A in which the radio wave sensor 100 is not installed is referred to as a “first standby area 21A”, and the standby area 21B provided in the sidewalk 61B in which the radio wave sensor 100 is installed is referred to as a “second standby area 21B”.

The detection area 30A is an area including the pedestrian crossing 20 and the first standby area 21A. The detection area 30B is an area including the second standby area 21B. The radio-wave radiation area 40B is set at a position closer to the radio wave sensor 100 than the radio-wave radiation area 40A.

Reference is made to FIGS. 1 and 4A. A radio wave sensor 100A radially radiates radio waves. The installation angle of the radio wave sensor 100A is adjusted so that the radio wave irradiation axis can detect the first standby area 21A of the sidewalk 61A without exception and is directed downward as much as possible. The radio wave irradiation axis is an axis that passes through the center of the transmission-reception surface and is perpendicular to the transmission-reception surface. The radio wave irradiation axis has the highest gain in the directivity of the plane (YZ plane in FIG. 4A) perpendicular to the transmission-reception surface. The radio wave sensor 100A is installed on the sidewalk 61B. The radio wave sensor 100A is not installed on the sidewalk 61A on the opposite side of the sidewalk 61B across the roadway 60. A portion of the radio wave is radiated obliquely upward from the radio wave sensor 100A installed in this manner.

The height of the pedestrian (or vehicle) on the pedestrian crossing 20 is a detection target, and is a range of h or less from the ground of the pedestrian (or vehicle). Thus, the radio wave sensor 100A is required to detect an object at a height of h or less. That is, the radio wave radiated above a height h is not used for object detection.

The second standby area 21B is set in a direction close to the radio wave sensor 100A (structure 50) from the boundary between the pedestrian crossing 20 and the sidewalk 61B, for example, with a width of 2 m or more (see FIG. 1). Here, a distance from an end close to the structure 50 in the second standby area 21B of the sidewalk 61B in which the radio wave sensor 100 is installed to the installation position of the structure 50 is referred to as “setback”. The setback must be greater than the width of the second standby area 21B. In order to set the width of the second standby area 21B with a width of 2 m or more, the setback needs to be set to 2 m or more.

In the radio wave sensor 100A in which the reflective plate 130 is not provided, unless the setback is sufficiently large, the radio wave having a sufficiently high strength cannot be radiated to the second standby area 21B. The detection accuracy of the object in the second standby area 21B may be lowered. Depending on the layout of the sidewalk 61B in which the radio wave sensor 100A is installed, it may be difficult to ensure a large setback. The degree of freedom in installation of the radio wave sensor 100A is limited. In contrast, in the radio wave sensor 100 provided with the reflective plate 130, the radio wave having a sufficiently high strength can be radiated to the second standby area 21B without increasing the setback. Thus, the degree of freedom in installation of the radio wave sensor 100 is improved.

Reference is made to FIG. 4B. The transmission antenna elements 121e, 121f, and 121g are configured to transmit radio waves toward the detection area 30A. The reception antenna elements 121a, 121b, 121c, and 121d are configured to receive the reflected waves that are radio waves reflected by an object in the detection area 30A.

Hereinafter, the reflected wave reflected by the object in the detection area 30A and directly received by the reception antenna elements 121a, 121b, 121c, and 121d (without passing through the reflective plate 130) is also referred to as a “directly reflected wave”.

A portion of the radio wave transmitted from the transmission antenna elements 121e, 121f, and 121g is directed to the reflective plate 130. The radio wave reflected by the reflective plate 130 is radiated to the detection area 30B. The reception antenna elements 121a, 121b, 121c, and 121d are configured to receive the reflected wave that is a radio wave reflected by an object in the detection area 30B through the reflective plate 130. Hereinafter, the reflected wave reflected by the object in the detection area 30B and received by the reception element antennas 121a, 121b, 121c, and 121d through the reflective plate 130 is also referred to as an “indirectly reflected wave”.

In the embodiment, a portion of the radio wave radiated upward from the radio wave sensor 100 is reflected by the reflective plate 130 and radiated to the ground. As described above, the radio wave radiated upward is not used for detecting an object.

However, the radio wave radiated upward is reflected by the reflective plate 130 and radiated to the ground, so that the radio wave can be used for object detection.

The radiation area 40B of the radio wave reflected by the reflective plate 130 is closer to the radio wave sensor 100 than the radio-wave radiation area 40A. Thus, even if the setback is reduced, the radio wave can be radiated to the second standby area 21B.

[3. Position Relationship between Antenna Region and Reflective Surface]Hereinafter, a position relationship between the antenna region 125 and the reflective surface 131 will be described.

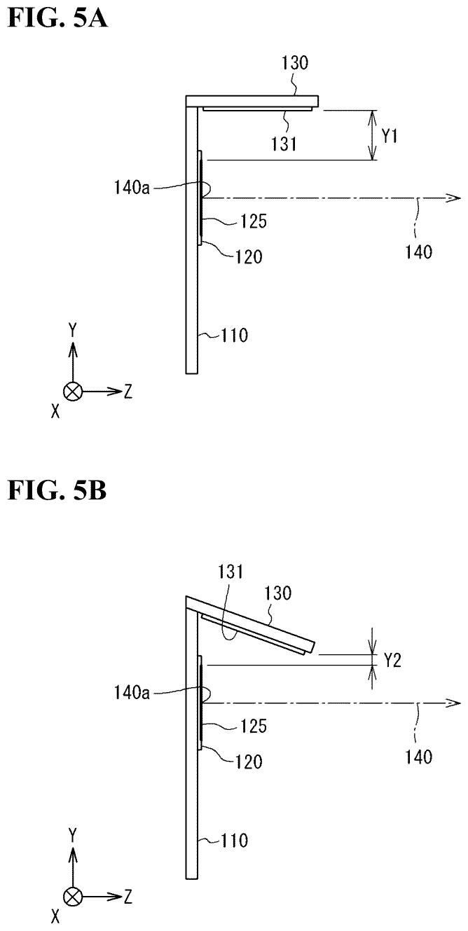

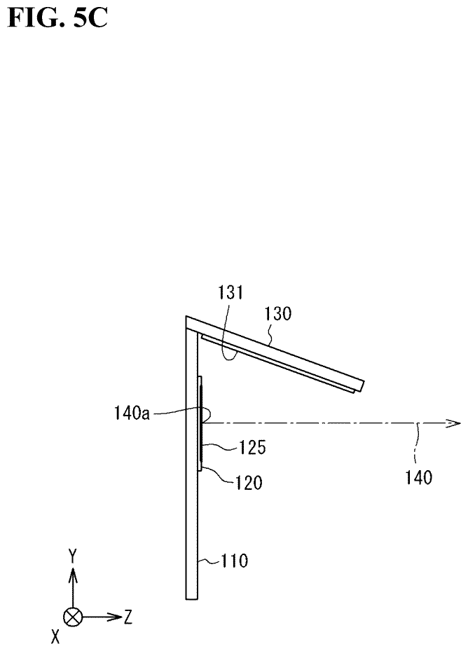

Reference is made to FIG. 5A.

As described above, the antenna region 125 is a partial area of the surface of the antenna portion 120, but in FIG. 5A, the antenna region 125 is indicated by a thick solid line for easy understanding. In the radio wave sensor 100 according to the embodiment, in a front view of the antenna region 125, the front end of the reflective surface 131 is located above the center of the antenna region 125. When a center axis 140 extending from a center 140a of the antenna region 125 in a normal direction (third direction Z) is assumed, the center axis 140 does not overlap the reflective surface 131. The center axis 140 is located below the reflective surface 131.

More specifically, in the example of FIG. 5A, the front end of the reflective surface 131 is located above the upper end of the antenna region 125. The front end of the reflective surface 131 and the upper end of the antenna region 125 are separated by a distance Y1 in an up-down direction.

The center axis 140 is a radio wave irradiation axis. From the antenna region 125, the main lobe is radiated along the center axis 140. Thus, most of the main lobe is not blocked by the reflective surface 131.

Here, “the front end of the reflective surface 131 is located above the center of the antenna region 125” means that a portion of the reflective surface 131 corresponding to the center axis 140 of the antenna region 125 in the X direction is located above the center axis 140. For example, even if a part of the front end of the reflective plate 130 protrudes and the protruding front end is positioned below the center axis 140, as long as a portion of the reflective surface 131 corresponding to the center axis 140 of the antenna region 125 in the X direction (for example, a central portion of the reflective surface 131 in the X direction) is located at least above the center axis 140, this is included in the expression “the front end of the reflective surface 131 is located above the center of the antenna region 125”. In this case, since the center axis 140 does not overlap the reflective surface 131, most of the main lobe is not blocked by the reflective surface 131.

For example, the center axis 140 is the center axis of the main lobe. That is, the front end of the reflective surface 131 is located above the center axis of the main lobe.

The center axis of the main lobe may be different from the center axis 140 of the antenna region 125. For example, a main lobe may be radiated from the antenna region 125 in a direction inclined downward by beamforming. In this case, the center axis of the main lobe extends in a direction different from the normal direction of the antenna region 125.

Reference is made to FIGS. 5B and 5C.

The reflective plate 130 may be inclined such that the front end thereof is lowered. However, as in the example of FIG. 5A, the center axis 140 is required to be located below the front end of the reflective surface 131.

In the example of FIG. 5B, the front end of the reflective surface 131 is located above the upper end of the antenna region 125. The front end of the reflective surface 131 and the upper end of the antenna region 125 are separated by a distance Y2 in the up-down direction. Thus, in the example of FIG. 5B, most of the main lobe is not blocked by the reflective surface 131.

In the example of FIG. 5C, the front end of the reflective surface 131 is located above the center axis 140 of the antenna region 125, but is located below the upper end of the antenna region 125. Even in such a configuration, only a part of the upper side of the main lobe is blocked by the reflective surface 131, and the main lobe having a sufficient range is ensured.

However, it is not desirable that the front end of the reflective surface 131 is located below the center of the antenna region 125. When the reflective surface 131 is provided up to such a range, most of the main lobe is reflected by the reflective surface 131, and the gain of the radio wave sensor is reduced.

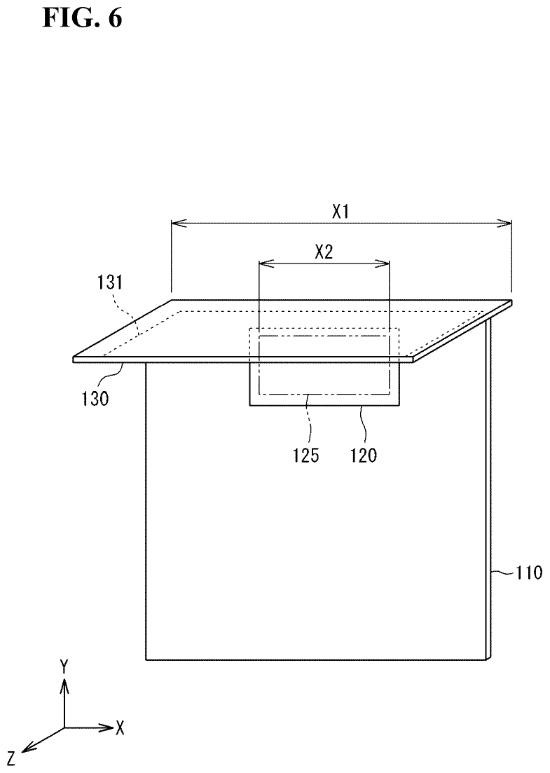

Next, a position relationship between the antenna region 125 and the reflective surface 131 in the first direction X will be described. Reference is made to FIG. 6.

In FIG. 6, X1 is the length of the reflective surface 131 along the first direction X, and X2 is the length of the antenna region 125 along the first direction. As described above, the antenna elements 121a, 121b, 121c, 121d, 121e, 121f, and 121g are arranged along the first direction X (see FIG. 3). Thus, X1 is the length of the reflective surface 131 in the first direction X that is the arrangement direction of the antenna elements 121a, 121b, 121c, 121d, 121e, 121f, and 121g and X2 is the length of the antenna region 125 in the first direction X.

As shown in FIG. 6, a length X1 of the reflective surface 131 is longer than a length X2 of the antenna region 125. Thus, most of the radio wave directing upward from the antenna region 125 can be reflected by the reflective surface 131.

### [4. Setting of Configuration of Reflective Surface]

The inventors constructed a model of an antenna with a reflective plate and a model of an antenna without a reflective plate on a computer and performed a simulation of antenna directivity.

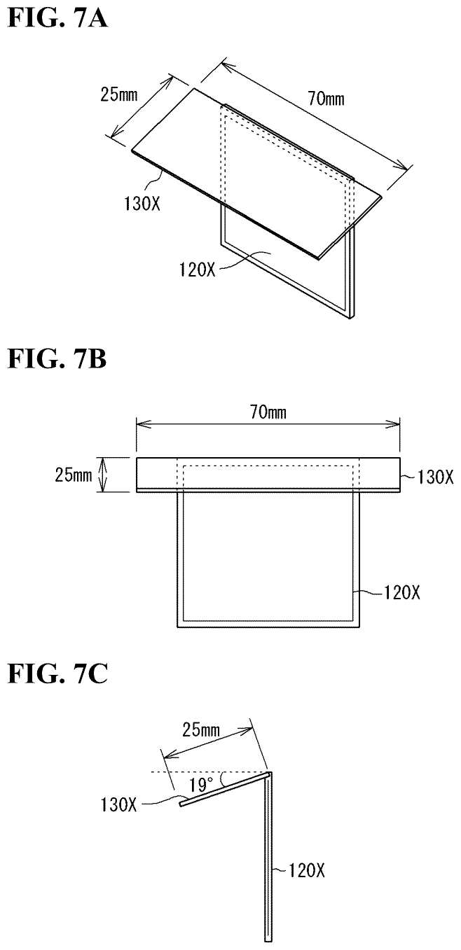

Reference is made to FIGS. 7A, 7B and 7C.

The horizontal width of a reflective plate 130X is 70 mm, and the vertical direction length of the reflective plate 130X is 25 mm. The entire lower surface of the reflective plate 130X is a reflective surface. The width of an antenna portion 120X is 47 mm, and the height of the antenna portion 120X is 8 mm. A base end of the reflective plate 130X is in contact with an upper end of the antenna portion 120X, and an angle (YZ plane angle) formed by the reflective plate 130X and the antenna portion 120X is 71°. The size and angle of the reflective plate 130X are determined so that the front end of the reflective plate 130X is positioned above the center of the antenna region when the antenna region of the antenna portion 120X is viewed from the front. An angle formed by the reflective plate 130X and the antenna portion 120X may be set in a range of 60° to 90°. Thus, the reflected wave can be radiated to an area close to the antenna.

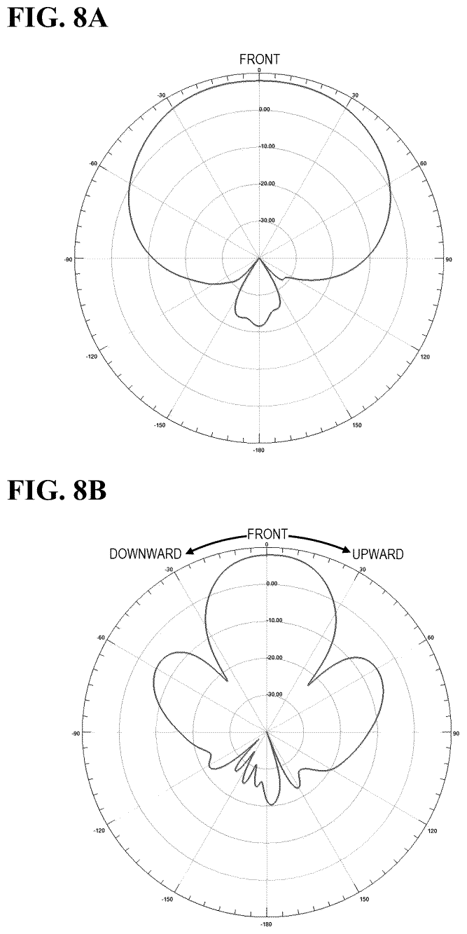

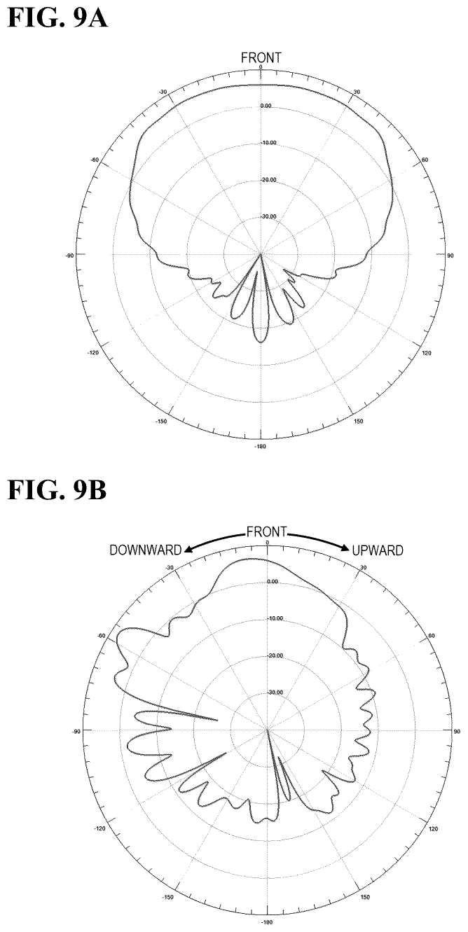

Reference is made to FIGS. 8A and 8B. Reference is made to FIGS. 9A and 9B. In FIGS. 8A and 9A, a radius indicates a gain (dBi), and a declination indicates an angle around the center 140a in the XY plane (the direction of the center axis 140 is set to 0°). In FIGS. 8B and 9B, a radius indicates a gain (dB), and a declination indicates an angle around the center 140 a in the YZ plane (the direction of the center axis 140 is 0°). The same applies to the following graphs.

When FIG. 8A and FIG. 9A are compared, a prototype antenna has a horizontal directivity substantially equal to a horizontal directivity of the antenna without a reflective plate.

When FIG. 8B and FIG. 9B are compared, the prototype has a gain improved at downward 50° to 60° (particularly, around 57°) than the gain of the antenna without a reflective plate. In the prototype, the gain in the range from upward 50° to 90° is reduced as compared to the antenna without the reflective plate. Such increase and decrease in gain is due to the provision of the reflective plate 130X.

The decrease in the gain in the range from upward 50° to 90° is considered to be due to the reflection of the radio wave toward this range by the reflective plate 130X.

The increase in the gain in the range from downward 50° to 60° is considered to be due to the fact that the radio wave in the range from upward 50° to 90° is reflected toward the range from downward 50° to 60° by the reflective plate 130X.

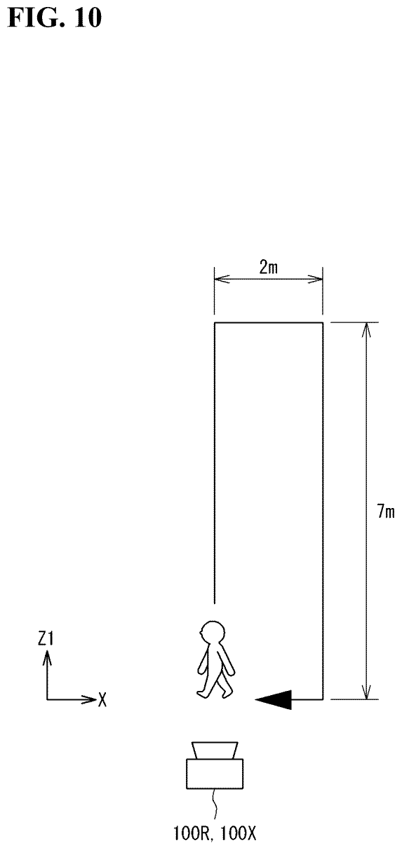

The inventors experimentally produced the antennas with reflective plates shown in FIGS. 7A, 7B, and 7C so as to have the antenna directivity shown in FIG. 9A and FIG. 9B, and performed a performance evaluation experiment for evaluating the detection performance of the antenna without a reflective plate and the prototype. Reference is made to FIG. 10. In the performance evaluation experiment, the subject walking in a pattern shown in FIG. 10 was detected by the antenna without the reflective plate and the prototype. In the walking pattern, the subject walked 7 m forward (Z1 direction that is a direction in which the Z direction is projected on the ground) from directly below the radio wave sensor 100, walked 2 m further to the right (X direction), walked 7 m further backward, and walked 2 m further to the right. The pedestrian started walking from a position where a position (Z1, X) with respect to the radio wave sensor was (0,0) (unit: [m]) to the Z1 direction, changed the traveling direction to the X direction when reaching a position (7,0), changed the traveling direction to the −Z1 direction when reaching a position (7,2), changed the traveling direction to −X when reaching a position (0,2), and returned to a position (0,0). In the experiment, while the subject was walking in the above-described pattern with respect to each of a radio wave sensor 100R equipped with the antenna without the reflective plate and a radio wave sensor 100X equipped with the antenna with the reflective plate of the prototype, the position of the subject was detected by each of the radio wave sensors 100R and 100X.

Reference is made to FIGS. 11A and 11B. FIGS. 11A and 11B shows detection results output from the radio wave sensors 100R and 100X described above at a predetermined cycle in a superimposed manner. In FIGS. 11A and 11B, a vertical axis represents the distance from the radio wave sensors 100R and 100X in the Z1 direction, and a horizontal axis represents the distance from the radio wave sensors 100R and 100X in the X direction. As shown in the frame of the dashed line in FIG. 11A, the antenna without the reflective plate cannot detect the subject in the range within 3 m in front of the radio wave sensor 100R. As shown in the frame of the dashed line in FIG. 11B, the prototype can detect the subject even in the range within 3 m in front of the radio wave sensor 100X. It is understood that the prototype has detection performance equivalent to detection performance of the antenna without the reflective plate even in the area other than the frame of the dashed line.

The simulation result of the antenna without the reflective plate shown in FIG. 8B and the experimental result of the antenna without the reflective plate shown in FIG. 11A are consistent. Similarly, the simulation result of the prototype shown in FIG. 9B and the experimental result of the prototype shown in FIG. 11B are consistent. That is, it can be seen that the gain obtained by the simulation is correlated with the detection result of the object by the radio wave sensor.

The inventors studied the configuration (shape, size, and position) of the reflective surface of various patterns.

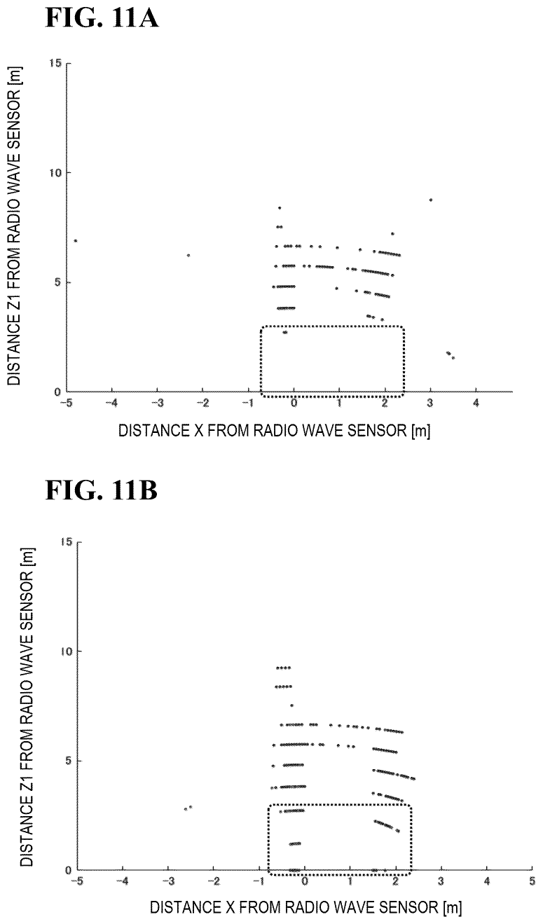

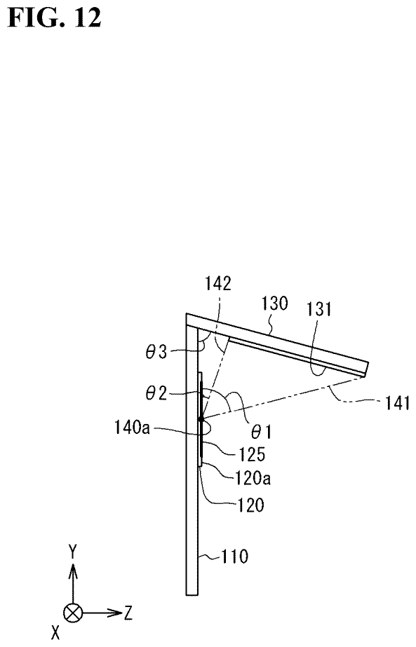

Reference is made to FIG. 12.

An angle formed by an antenna surface 120a and a first straight line 141 connecting the front end of the reflective surface 131 and the center 140a of the antenna region 125 in a plane perpendicular to the first direction X is referred to as θ1. The antenna surface 120a is a main surface of the antenna portion 120, and is a plane on which the antenna elements 121a, 121b, 121c, 121d, 121e, 121f, and 121g are arranged. In FIGS. 7, θ2 is an angle formed by the antenna surface 120 a and a second straight line 142 connecting the base end of the reflective surface 131 and the center 140a of the antenna region 125 in a plane perpendicular to the first direction X. An angle formed by the antenna surface 120a and the reflective plate 130 (reflective surface 131), that is, an inclination angle of the reflective plate 130 with respect to the antenna surface 120a is referred to as θ3.

The larger an angle θ1 is, the larger the length of the forward projection of the reflective surface 131 is. Thus, as the angle θ1 increases, the range in which the radio wave directed upward is reflected by the reflective surface 131 increases forward. However, when the reflective plate 130 is inclined such that the front end of the reflective plate 130 is lowered, the range in which the reflective surface 131 covers the antenna region 125 at the front side portion becomes larger as the angle θ1 becomes larger, and the range in which the radio wave radiated forward from the antenna region 125 is blocked becomes larger. The angle θ1 is set in a range of more than 0° and less than 90°.

As an angle θ2 is smaller, the base end portion of the reflective surface 131 is closer to the antenna region 125, and the range in which the radio wave directed upward is reflected by the reflective surface 131 is increased backward. In other words, as the angle θ2 increases, the distance between the reflective surface 131 and the antenna region 125 increases, and the amount of radio waves radiated upward through the distance increases. The angle θ2 is set in a range of more than 0° and less than 90°.

The inventors simulated the directivity of the antenna by the radio wave sensor 100 for a plurality of patterns of combinations of θ1 and θ2. An angle θ3 was set to 71°.

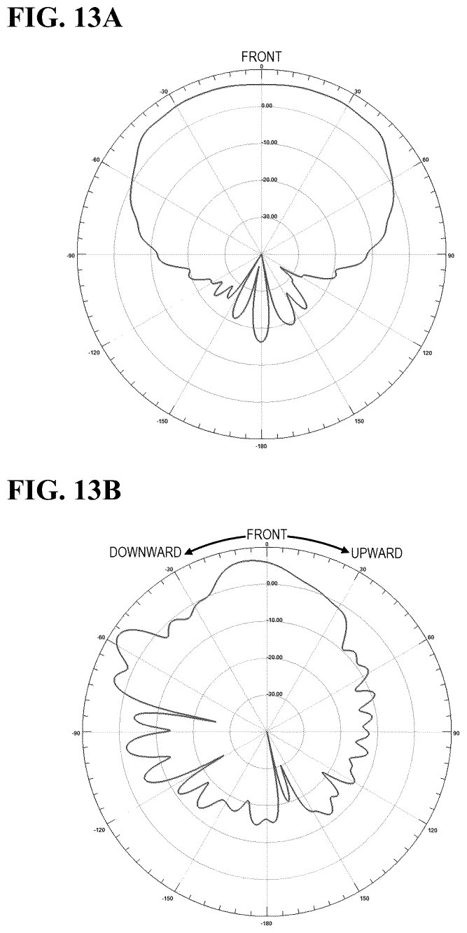

Reference is made to FIGS. 13A and 13B.

When FIG. 8A and FIG. 13A are compared, in the case of θ1=80° and θ2=25°, on the front side of the antenna related to the detection of the object (within the range from leftward 90° to rightward 90° with respect to a front direction), the horizontal directivity substantially equivalent to the horizontal directivity of the antenna without the reflective plate was obtained.

On the other hand, when FIG. 8B and FIG. 13B are compared, in the case of θ1=80° and θ2=25°, the gain is improved at downward 50° to 60° (particularly, around 57°) than the gain of the antenna without the reflective plate. On the other hand, in the case of θ1=80° and θ2=25°, the gain is reduced in the range from upward 50° to 90° than the gain of the antenna without the reflective plate. The simulation results in the case of θ1=80° and θ2=25° are equivalent to the simulation result (see FIG. 9B) in the above-described prototype. When the reflective surface of the reflective plate 130X is θ1=80° and θ2=25°, a good result is obtained as in the prototype even though the reflective surface is smaller than the reflective surface of the prototype.

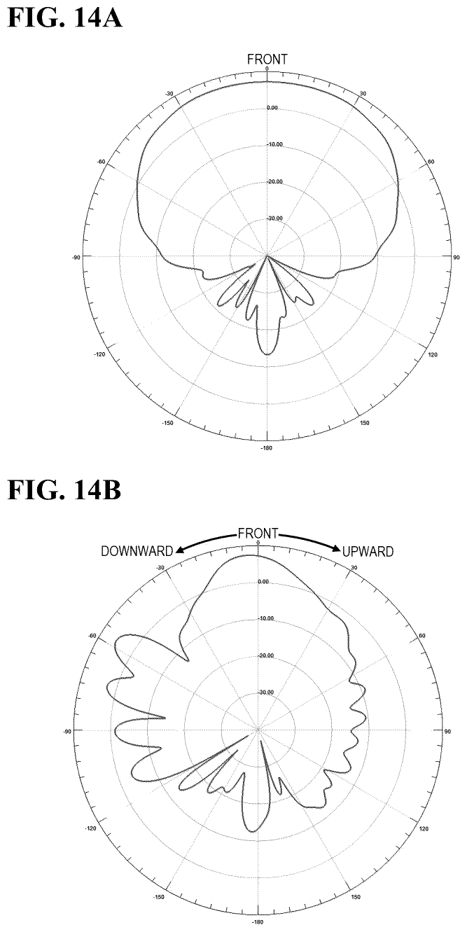

Reference is made to FIGS. 14A and 14B.

When FIG. 8A and FIG. 14A are compared, in the case of θ1=75° and θ2=25°, on the front side of the antenna related to the detection of the object, the horizontal directivity substantially equivalent to the horizontal directivity of the antenna without the reflective plate was obtained.

In the simulation result shown in FIG. 14B, the gain at downward 50° to 60° is reduced by about 1 dB as compared to the case of θ1=80° and θ2=25°, but it is considered that a gain necessary for detecting an object can be ensured.

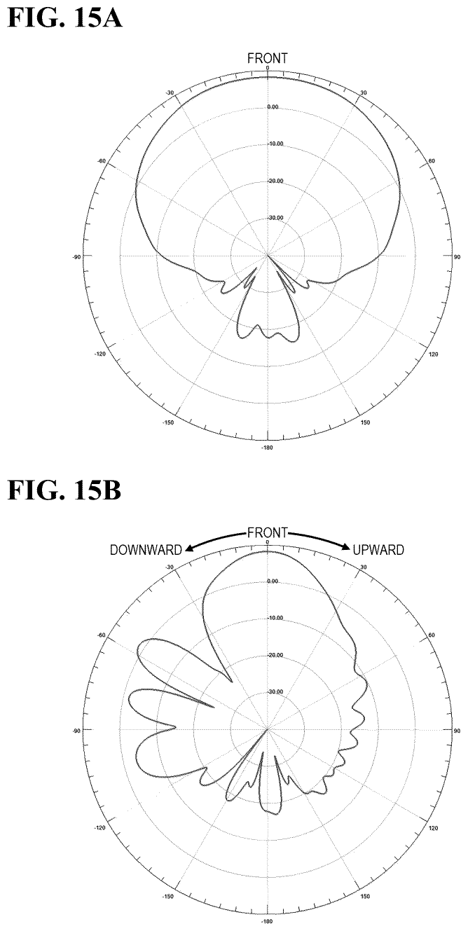

Reference is made to FIGS. 15A and 15B.

When FIG. 8A and FIG. 15A are compared, in the case of θ1=70° and θ2=25°, on the front side of the antenna related to the detection of the object, the horizontal directivity substantially equivalent to the horizontal directivity of the antenna without the reflective plate was obtained.

In the simulation result shown in FIG. 15B, the gain at downward 50° to 60° is reduced by 5 dB as compared to the case of θ1=80° and θ2=25°, and is not sufficient for detecting an object.

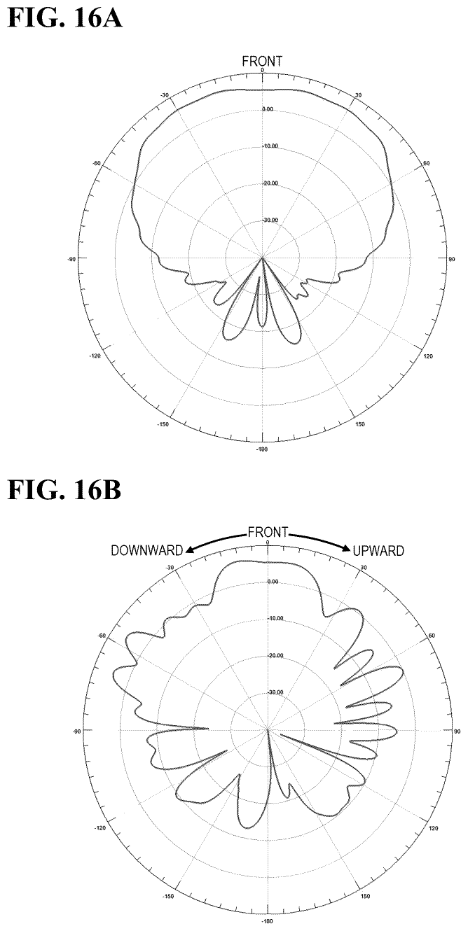

Reference is made to FIGS. 16A and 16B.

When FIG. 8A and FIG. 16A are compared, in the case of θ1=80° and θ2=30°, on the front side of the antenna related to the detection of the object, the horizontal directivity substantially equivalent to the horizontal directivity of the antenna without the reflective plate was obtained.

In the simulation result shown in FIG. 16B, the gain at downward 50° to 60° is reduced by about 1 dB as compared to the case of θ1=80° and θ2=25°, but it is considered that a gain necessary for detecting an object can be ensured.

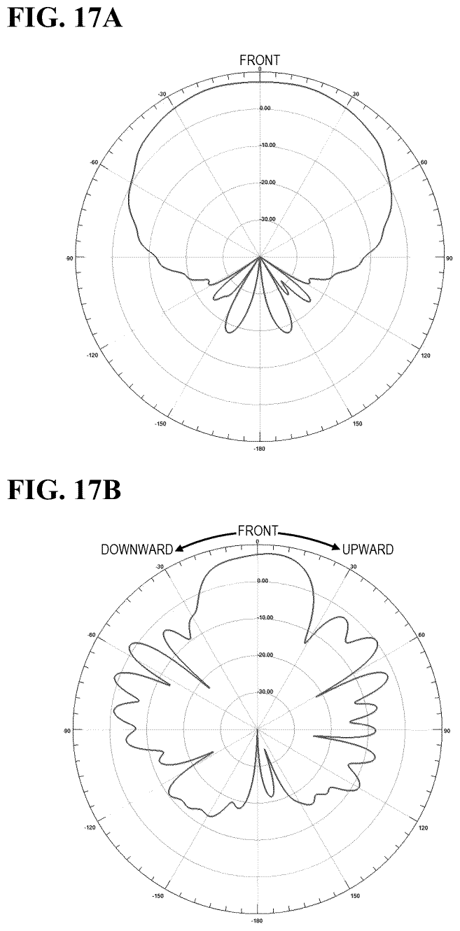

Reference is made to FIGS. 17A and 17B.

When FIG. 8A and FIG. 17A are compared, in the case of θ1=80° and θ2=35°, on the front side of the antenna related to the detection of the object, the horizontal directivity substantially equivalent to the horizontal directivity of the antenna without the reflective plate was obtained.

In the simulation result shown in FIG. 17B, the gain at downward 50° to 60° is reduced by 5 dB as compared to the case of θ1=80° and θ2=25°, and is not sufficient for detecting an object.

As described above, when θ1 is set to 75° or more, a gain necessary for object detection can be obtained. When θ2 is 30° or less, a gain necessary for object detection can be obtained. Thus, in the plane perpendicular to the first direction X, an angle formed by the first straight line 141 connecting the front end of the reflective surface 131 and the center 140a of the antenna region 125 and the antenna surface 120a may be 75° or more. In the plane perpendicular to the first direction X, an angle formed by the second straight line 142 connecting the base end of the reflective surface 131 and the center 140a of the antenna region 125 and the antenna surface 120a may be 30° or less. When θ1 is 80° or more, the gain is further improved. Thus, in the plane perpendicular to the first direction X, an angle formed by the first straight line 141 connecting the front end of the reflective surface 131 and the center 140a of the antenna region 125 and the antenna surface 120a may be 80° or more. When θ2 is 25° or less, the gain is further improved. Thus, in the plane perpendicular to the first direction X, an angle formed by the second straight line 142 connecting the base end of the reflective surface 131 and the center 140a of the antenna region 125 and the antenna surface 120a may be 25° or less.

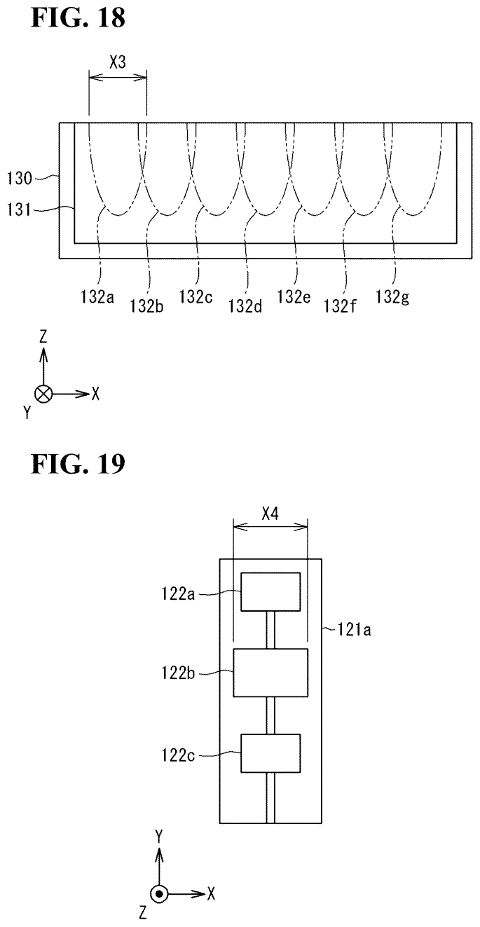

In the reflective surface 131, a reflection region of a radio wave corresponding to each of the antenna elements 121a, 121b, 121c, 121d, 121e, 121f, and 121g is determined. Reference is made to FIG. 18.

In FIG. 18, a reflection region 132a corresponds to the antenna element 121a. That is, the radio wave reflected in the reflection region 132a is received by the antenna element 121a. A reflection region 132b corresponds to the antenna element 121b, and the radio wave reflected in the reflection region 132b is received by the antenna element 121b. A reflection region 132c corresponds to an antenna element 121c, and the radio wave reflected in the reflection region 132c is received by the antenna element 121c. A reflection region 132d corresponds to an antenna element 121d, and the radio wave reflected in the reflection region 132d is received by the antenna element 121d. A reflection region 132e corresponds to the antenna element 121e, and the radio wave radiated from the antenna element 121e is reflected in the reflection region 132e. A reflection region 132f corresponds to the antenna element 121f, and the radio wave radiated from the antenna element 121f is reflected in the reflection region 132f. A reflection region 132g corresponds to the antenna element 121g, and the radio wave radiated from the antenna element 121g is reflected in the reflection region 132g.

Each of the reflection regions 132a, 132b, 132c, 132d, 132e, 132f, and 132g is an area where a radio wave having a strength sufficient for object detection is reflected.

Each of the reflection regions 132a, 132b, 132c, 132d, 132e, 132f, and 132g may be defined as an area including at least an area in which the strength of the radio wave radiated from each of the antenna elements 121a, 121b, 121c, 121d, 121e, 121f, and 121g is not less than −3 dB relative to radio wave strength of a peak of the main lobe.

Adjacent reflection regions partially overlap each other. A portion of the reflection region 132a and a portion of the reflection region 132b overlap each other. A portion of the reflection region 132b and a portion of the reflection region 132c overlap each other. A portion of the reflection region 132c and a portion of the reflection region 132d overlap each other. A portion of the reflection region 132d and a portion of the reflection region 132e overlap each other. A portion of the reflection region 132e and a portion of the reflection region 132f overlap each other. A portion of the reflection region 132f and a portion of the reflection region 132g overlap each other.

The reflective surface 131 may include all of the reflection regions 132a, 132b, 132c, 132d, 132e, 132f, and 132g. In this case, the left end of the reflection region 132a at the leftmost side and the right end of the reflection region 132g at the rightmost side are included in the range of the reflective surface 131.

Reference is made to FIG. 19. Here, the antenna element 121a will be described as a representative, but the same applies to the antenna elements 121b, 121c, 121d, 121e, 121f, and 121g.

The antenna element 121a is an array antenna including three elements 122a, 122b, and 122c arranged in the second direction Y. A length X4 (hereinafter also referred to as “element width”) of the antenna element 121a in the first direction X is defined by the length in the first direction of the element 122b that is the middle element among the elements 122a, 122b, and 122c. The element 122b is an element having the largest length in the first direction X among the elements 122a, 122b, and 122c.

The length of the reflective surface 131 in the first direction X may be determined based on the element width X4. For example, a length X3 (hereinafter, also referred to as “area width”) (see FIG. 18) in the first direction X of each of the reflection regions 132a, 132b, 132c, 132d, 132e, 132f, and 132g is determined by the element width X4, and the length in the first direction X of the reflective surface 131 may be determined so that all of the reflection regions 132a, 132b, 132c, 132d, 132e, 132f, and 132g are included in the reflective surface 131.

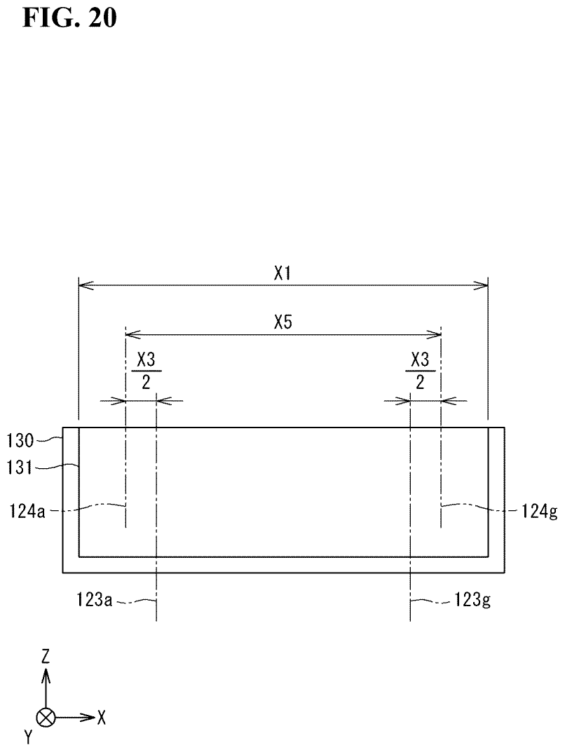

Reference is made to FIG. 20. A straight line 123a is a straight line obtained by projecting a center line of the antenna element 121a at the leftmost side in the first direction X onto the reflective surface 131 along a direction perpendicular to the first direction X. A straight line 123g is a straight line obtained by projecting a center line of the antenna element 121g at the rightmost side in the first direction X onto the reflective surface 131 along a direction perpendicular to the first direction X. The reflective surface 131 includes an area between a straight line 124a located half of the area width X3 leftward from the straight line 123a in the first direction X and a straight line 124g located half of the area width X3 rightward from the straight line 123g in the first direction X. That is, the length X1 of the reflective surface 131 in the first direction X is equal to or more than the length between the straight line 124a and the straight line 124g, that is, the length X5 between the left end of the reflection region 132a at the leftmost side and the right end of the reflection region 132g at the rightmost side in the first direction X.

That is, the longer the area width X3 is, the longer the length X1 of the reflective surface 131 in the first direction X is. When the length X1 of the reflective surface 131 in the first direction X is increased, radio waves on both left and right sides among radio waves radiated upward from the antenna region 125 may be prevented from deviating from the reflective surface 131.

The inventors simulated the directivity of the antenna by the radio wave sensor 100 for a plurality of patterns of the area width X3. Here, the area width X3 is defined as a constant multiple of the element width X4 (X3=a×X4).

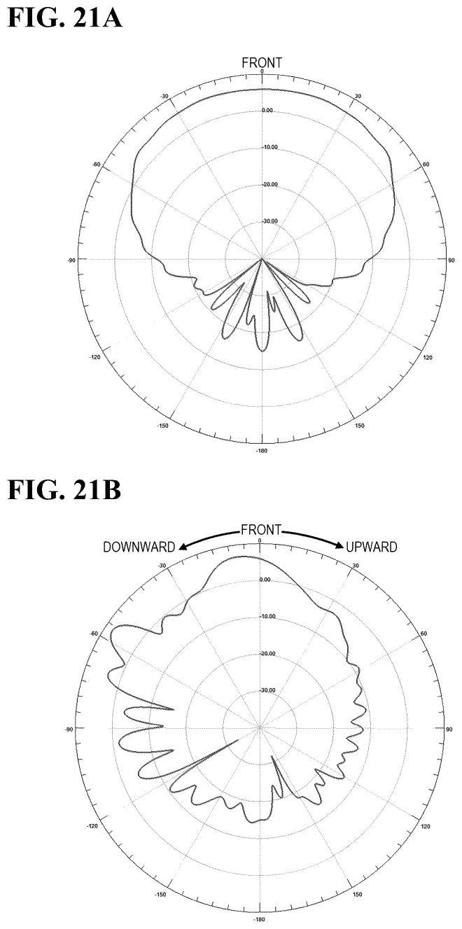

Reference is made to FIGS. 21A and 21B.

When FIG. 8A and FIG. 21A are compared, in the case of a=10, on the front side of the antenna related to detection of the object, the horizontal directivity substantially equivalent to the horizontal directivity of the antenna without the reflective plate was obtained.

When FIG. 8B and FIG. 21B are compared, in the case of a=10, the gain is improved at downward 50° to 60° (particularly, around 57°) as compared to the antenna without the reflective plate. In the case of a=10, the gain is reduced in the range from upward 50° to 90° as compared to the antenna without the reflective plate. The simulation result in the case of a=10 is equivalent to the simulation result (see FIG. 9B) in the above-described prototype. In the case of a=10, the length X1 of the reflective surface 131 in the first direction X is sufficiently large, and it can be said that a good result is obtained.

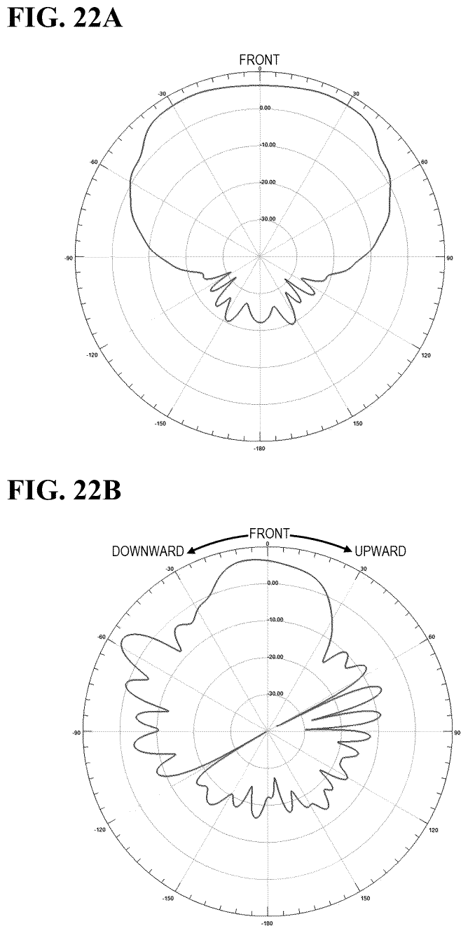

Reference is made to FIGS. 22A and 22B.

When FIG. 8A and FIG. 22A are compared, in the case of a=4, on the front side of the antenna related to the detection of the object, the horizontal directivity substantially equivalent to the horizontal directivity of the antenna without the reflective plate was obtained.

In the simulation result shown in FIG. 22B, it is considered that the gain at downward 50° to 60° is reduced by about 1 dB as compared to the case of a=10, but the gain of a degree necessary for detecting the object can be ensured.

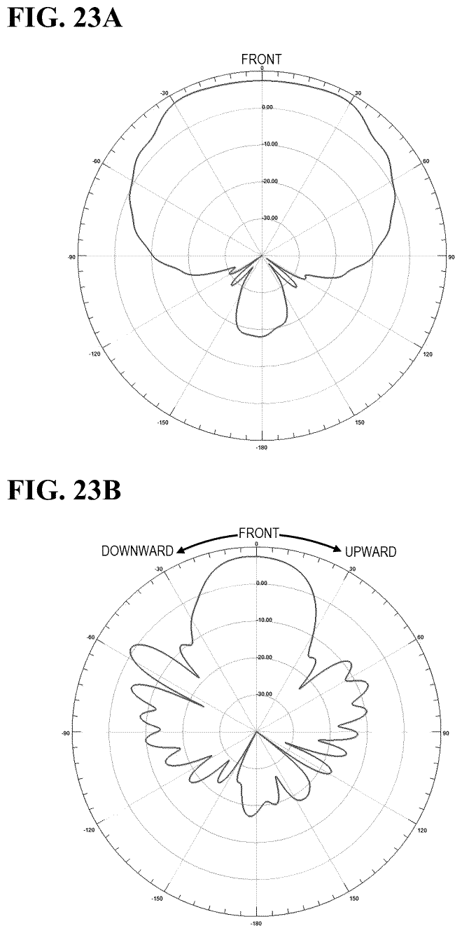

Reference is made to FIGS. 23A and 23B.

When FIG. 8A and FIG. 23A are compared, in the case of a=1, on the front side of the antenna related to the detection of the object, the horizontal directivity substantially equivalent to the horizontal directivity of the antenna without the reflective plate was obtained.

In the simulation result shown in FIG. 23B, the gain at downward 50° to 60° is reduced by 5 dB as compared to the case of a=10, and is not sufficient for detecting the object.

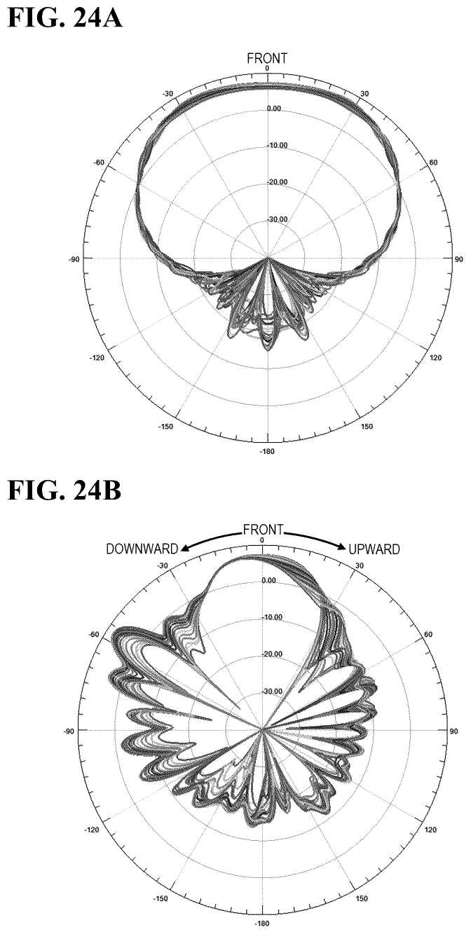

Reference is made to FIGS. 24A and 24B.

When FIG. 8A and FIG. 24A are compared, it is found that even if X3 is changed, the horizontal directivity on the front side of the antenna in particular does not substantially change, and the horizontal directivity substantially equivalent to the horizontal directivity of the antenna without the reflective plate is obtained.

In the simulation result shown in FIG. 24B, the gain downward increases as X3 increases. However, when a is seven or more, the gain does not substantially increase.

As described above, when a is set to four or more, a gain necessary for object detection can be obtained. The area width X3 may be four times or more the element width X4 of the antenna element. Further, since the gain is not improved in the case of a=7, the area width X3 can be set to be equal to or less than seven times the element width X4 of the antenna element.

### [5. Modification]

The reflective plate 130 may be a reflectarray reflective plate. By appropriately setting the reflection angle of the radio wave of the reflectarray reflective plate, the radiation area 40B (see FIG. 4B) of the radio wave reflected by the reflective plate 130 can be adjusted regardless of the angle (θ3 in FIG. 12) between the reflective plate and the antenna surface 120a.

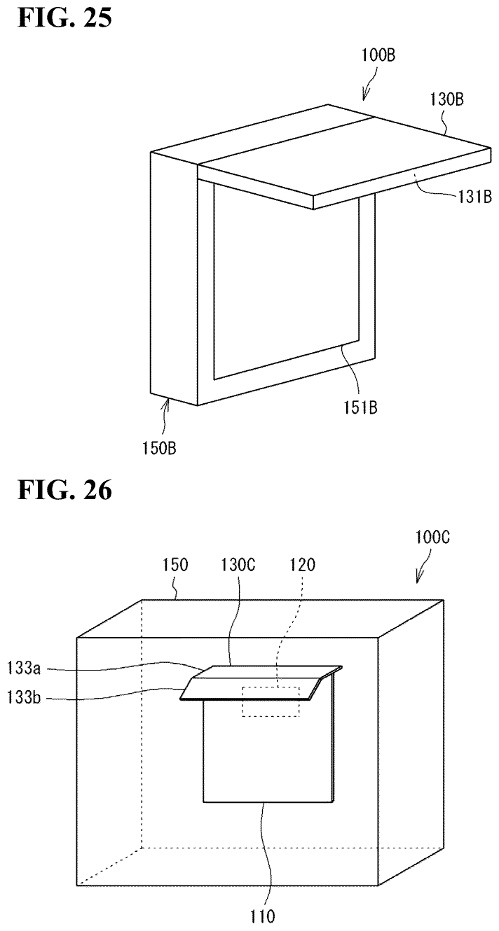

In the above-described embodiment, the reflective plate 130 is housed in the housing 150, but the present disclosure is not limited thereto. Reference is made to FIG. 25. In a first modification shown in FIG. 25, a reflective plate 130B is arranged outside a housing 150B of a radio wave sensor 100B. Specifically, the reflective plate 130B is attached to above a transmission-reception surface 151B of the housing 150B. The lower surface of the reflective plate 130B is a reflective surface 131B. Even with this configuration, a portion of the radio wave radiated upward from the transmission-reception surface 151B can be reflected downward by the reflective surface 131B of the reflective plate 130B, and the detection area can be enlarged.

In the above-described embodiment, the reflective plate 130 is a flat plate, but the present disclosure is not limited thereto. Reference is made to FIG. 26. In a radio wave sensor 100C according to a second modification shown in FIG. 26, a reflective plate 130C is formed in a bent plate shape. That is, the reflective plate 130C includes a first portion 133a and a second portion 133b. One end of the first portion 133a is fixed to the housing 150. Each of the first portion 133a and the second portion 133b has a flat plate shape, and a predetermined angle other than 0° is provided between the first portion 133a and the second portion 133b.

In the second modification, a reflective surface is provided in at least one of the first portion 133a and the second portion 133b. That is, the reflective surface may be provided on the lower surfaces of both the first portion 133a and the second portion 133b, the reflective surface may be provided only on the lower surface of the first portion 133a, or the reflective surface may be provided only on the lower surface of the second portion 133b.

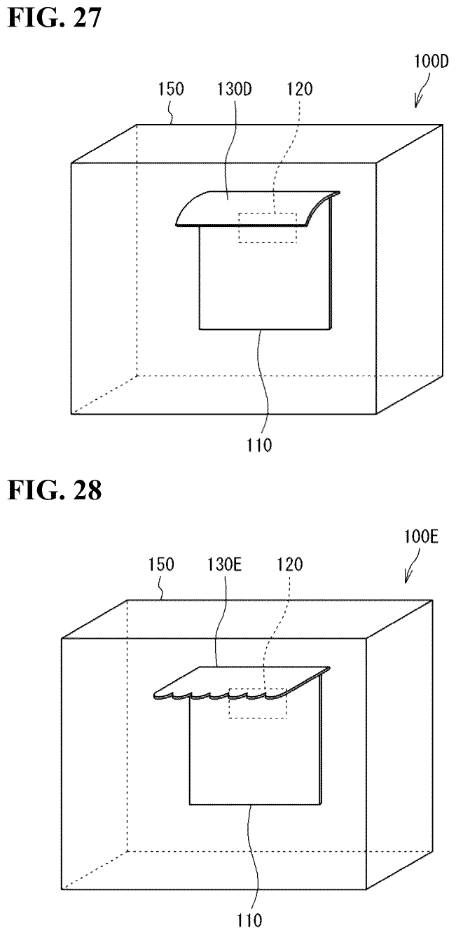

Reference is made to FIG. 27. In a radio wave sensor 100D according to a third modification shown in FIG. 27, a reflective plate 130D is formed in a plate shape curved in an arc shape. For example, the curvature of the reflective plate 130D may be constant, or the curvature may change in the middle.

In the third modification, a reflective surface is provided on at least a portion of the lower surface of the reflective plate 130D. That is, the reflective surface may be provided on the entire lower surface of the reflective plate 130D, the reflective surface may be provided only on the front portion of the lower surface of the reflective plate 130D, or the reflective surface may be provided only on the rear portion of the reflective plate 130D.

Reference is made to FIG. 28. In a radio wave sensor 100E according to a fourth modification shown in FIG. 28, a reflective plate 130E does not have a rectangular shape but has a shape based on the strength distribution of the radio wave reflected from the reflective plate 130E. Specifically, the front end of the reflective plate 130E has a shape in which a plurality of parabolic protrusions are arranged in the X direction. Each protrusion has the same shape as the outer edge of the reflection regions 132a, 132b, 132c, 132d, 132e, 132f, and 132g shown in FIG. 18. That is, the front end of the reflective plate 130E has a shape obtained by connecting the outer edges of the reflection regions 132a, 132b, 132c, 132d, 132e, 132f, and 132g. Thus, the reflective plate 130E can reflect a radio wave having a strength sufficient for object detection, and the reflective plate 130E can be configured to be small.

The embodiments disclosed herein are illustrative in all respects and are not restrictive. The scope of the present invention is defined by the appended claims rather than the foregoing description, and all changes that come within the meaning and range of equivalency of the claims are intended to be embraced therein.

### REFERENCE SIGNS LIST

10 pedestrian traffic signal
20 pedestrian crossing
21A, 21B standby area
30A, 30B detection area
40A, 40B radio-wave radiation area
50 structure
60 roadway
61A, 61B sidewalk
100, 100A, 100B, 100C, 100D, 100E, 100R, 100X radio wave sensor
110 circuit board
111 detection processing circuit
112 power supply circuit
113 interface portion
120, 120X antenna portion
120a antenna surface
121a, 121b, 121c, 121d, 121e, 121f, 121g antenna element
122a, 122b, 122c element
123a, 123g, 124a, 124g straight line
125 antenna region
130, 130B, 130C, 130D, 130E, 130X reflective plate
131, 131B reflective surface
132a, 132b, 132c, 132d, 132e, 132f, 132g reflection region
133a first portion
133b second portion
140 center axis
140a center
141 first straight line
142 second straight line
150, 150B housing (holding portion)
151B transmission-reception surface
h installation height of radio wave sensor
Y1, Y2 distance between front end of reflective surface and upper end of antenna region
X1 length of reflective surface in first direction
X2 length of antenna region in first direction
X3 length of reflection region in first direction
X4 length of antenna element in first direction
X5 length in first direction between left end of reflection region at leftmost side and right end of reflection region at rightmost side.

1. A radio wave sensor comprising:
an antenna portion including a plurality of antenna elements configured to transmit and receive a radio wave;
a housing configured to house the antenna portion; and
a reflective plate having a reflective surface configured to reflect a portion of the radio wave transmitted or received by the antenna portion,
wherein the antenna portion has an antenna region that is a region in which the plurality of antenna elements are arranged and in which the radio wave is transmitted and received,
wherein the reflective plate is arranged such that the reflective surface faces downward, and
wherein, in a front view of the antenna region, a front end of the reflective surface is located above a center of the antenna region.

2. The radio wave sensor according to claim 1,
wherein the front end of the reflective surface is located above an upper end of the antenna region.

3. The radio wave sensor according to claim 1-or
wherein the antenna portion further has an antenna surface that is a flat surface on which the plurality of antenna elements are arranged in a first direction that is a horizontal direction, and
wherein, in a plane perpendicular to the first direction, an angle formed by the antenna surface and a first straight line connecting the front end of the reflective surface and the center of the antenna region to each other is 75° or more.

4. The radio wave sensor according to claim 3,
wherein, in a plane perpendicular to the first direction, an angle formed by the antenna surface and a second straight line connecting a base end of the reflective surface and the center of the antenna region to each other is 30° or less.

5. The radio wave sensor according to claim 1,
wherein the antenna portion further has an antenna surface that is a flat surface on which the plurality of antenna elements are arranged in a first direction that is a horizontal direction, and wherein an angle formed by the reflective surface and the antenna surface is within a range of 60° to 90°.

6. The radio wave sensor according to claim 1,
wherein a length of the reflective surface in the first direction is larger than or equal to a length of the antenna region in the first direction that is a horizontal direction.

7. The radio wave sensor according to claim 6,
wherein a length of the reflective surface in the first direction is a length including a plurality of reflection regions each determined for a respective one of the plurality of antenna elements.

8. The radio wave sensor according to claim 7,
wherein a length of the reflection region in the first direction is larger than or equal to four times a length of each of the antenna elements in the first direction.

9. The radio wave sensor according to claim 7,
wherein the reflection region includes a region in which strength of a radio wave radiated from the antenna elements is not less than −3 dB relative to radio wave strength of a peak of a main lobe.

10. The radio wave sensor according to claim 1, further comprising:
a holding portion configured to hold the antenna portion, wherein the reflective plate is attached to the holding portion.

11. The radio wave sensor according to claim 1,
wherein the housing is configured to house the reflective plate.

12. The radio wave sensor according to claim 1,
wherein the reflective plate is a flat plate having a rectangular shape.

13. The radio wave sensor according to claim 1,
wherein the antenna portion further has an antenna surface that is a flat surface on which the plurality of antenna elements are arranged in a first direction that is a horizontal direction, and
wherein the reflective plate has a plate shape having a bent portion in a direction away from the antenna portion, and includes a first portion closer than the bent portion to the antenna portion and a second portion farther than the bent portion from the antenna portion, and
wherein an angle formed by the second portion and the antenna surface is smaller than an angle formed by the first portion and the antenna surface.

14. The radio wave sensor according to claim 1,
wherein the reflective plate has a plate shape curved such that a front end thereof is lowered.

15. The radio wave sensor according to claim 1,
wherein a front end of the reflective plate has a shape based on a strength distribution of a radio wave reflected by the reflective surface.

16. The radio wave sensor according to claim 1,
wherein the reflective surface is configured to cause a reflected wave, the reflected wave being the radio wave that is reflected, to be radiated to a second radiation range closer than a first radiation range to the radio wave sensor, the first radiation range being a range in which the radio wave is radiated to a ground from the antenna portion without being reflected by the reflective surface.

17. A radio wave sensor comprising:
an antenna portion including a plurality of antenna elements configured to transmit and receive a radio wave;
a housing configured to house the antenna portion; and
a reflective plate configured to reflect a portion of the radio wave transmitted or received by the antenna portion,
wherein the reflective plate is arranged such that a reflective surface thereof faces downward, the reflective surface being configured to reflect the radio wave, and
wherein a front end of the reflective surface is located above a center axis of a main lobe radiated from the antenna portion.
